(19) United States
(12) Patent Application Publication
(10) Pub. No.: US 2015/0032470 A1
(43) Pub. Date: Jan. 29, 2015

(54) SYSTEM AND METHOD FOR ASSISTING IN THE HOME TREATMENT OF A MEDICAL CONDITION

(71) Applicant: Novo Nordisk A/S, Bagsvaerd (DK)

(72) Inventors: Jens Bjerre Knudsen, Farum (DK); Amy D. Shapiro, Indianapolis, IN (US)

(21) Appl. No.: 14/512,740

(22) Filed: Oct. 13, 2014

Related U.S. Application Data
(63) Continuation of application No. 13/188,661, filed on Jul. 22, 2011, now abandoned.
Application No. 13/188,661 is a continuation of application No. 12/964,216, filed on Dec. 9, 2010, now abandoned.
Application No. 12/964,216 is a continuation of application No. 12/701,948, filed on Feb. 8, 2010, now abandoned.
Application No. 12/701,948 is a continuation of application No. 10/743,621, filed on Dec. 22, 2003, now abandoned.
Application No. 10/743,621 is a continuation of application No. 10/438,543, filed on May 15, 2003, now abandoned.
(60) Provisional application No. 60/381,011, filed on May 15, 2002.

(51) Int. Cl. G06F 19/00

(52) U.S. Cl. CPC G06F 19/3418
USPC 705/2

(57) ABSTRACT

An interactive home treatment system and method is disclosed. Patient data is collected via a handheld device and stored in a database. The data may be related to self-treatments, symptoms, or patient behavior. The data are analyzed with an analytic tool and the analysis is used to generate a message that is transmitted to a treating health care professional or to the patient, or both. A set of predetermined rules may be applied to the data. The rules may be modified by the treating health care professional, the patient, or both. The handheld device, the database, and the analytic tool may be web-enabled to facilitate communication from virtually anywhere.

### CROSS REFERENCE TO RELATED APPLICATIONS

This application is a continuation of U.S. application Ser. No. 13/188,661, filed Jul. 22, 2011, which is a continuation of U.S. application Ser. No. 12/964,216 filed Dec. 9, 2010 (abandoned) which is a continuation of U.S. application Ser. No. 12/701,948 filed Feb. 8, 2010 (abandoned), which is a continuation of U.S. application Ser. No. 10/743,621 filed Dec. 22, 2003 (abandoned), which is a continuation of U.S. application Ser. No. 10/438,543 filed on May 15, 2003 (abandoned), and claims priority under 35 U.S.C. 119 of U.S. provisional application No. 60/381,011 filed May 15, 2002, the contents of all of which are fully incorporated herein by reference.

### FIELD OF THE INVENTION

The present invention relates to methods and systems for interactive home treatment of chronic and/or episodic diseases. While the present invention is particularly useful in the field of hemophilia, it is also useful with other chronic and/or episodic diseases and is therefore not limited to one particular field.

### BACKGROUND OF THE INVENTION

Advances in medical technology and the rising costs of medical care have resulted in an increasing number of patients who self-administer medications and treatments outside of a doctor's office or a medical facility. The success of such treatments, however, depends on appropriate patient compliance and carries the risk of under-treatment, over-treatment, or inappropriate treatment. Thus, there is a need in the art for methods and systems that facilitate home treatments and enhance their overall safety, efficacy, and cost-effectiveness.

In the field of hemophilia, for example, most patients visit a hemophilia center infrequently and treat bleeds at home through self-administration of medication. Some studies have shown that more than 80% of hemophilia drugs are used outside clinics and hospitals. The regular and systematic evaluation of home treatment is therefore critical to patient welfare and treatment optimization.

### SUMMARY OF THE INVENTION

The present invention provides methods and systems for interactive home treatment of patients, including, without limitation, those suffering from diseases or syndromes that are chronic and/or episodic. The present invention provides for a personalized system for rapidly transmitting individual treatment data over a communications network to a treatment center, thus facilitating earlier identification of clinical problems. A hand-held, pocket PC or a personalized secure website may be used to enter data. The data may be encrypted to ensure patient confidentiality.

When used in the field of hemophilia, for example, the data collected include pertinent information on the time and date of an infusion of a treating agent, batch number of product, reasons for the infusion, product used, site and type of bleed (using a detailed and versatile body figure), response to infusion, etc. Data input can be augmented through use of drop-down menus, pop-up screens, and easily interpreted questions and suggested answers. Systems can be designed to allow data entry in under one minute per infusion. And the system can be configured to allow patients to communicate and hold discussions with treating centers.

A computerized system analyzes incoming data and flags any deviation from established center standards and criteria. In addition, individual or combined patient data can be analyzed to allow easy evaluation of resource utilization, patient compliance, and response to therapy.

In some embodiments, patients/parents can use the system to analyze their own past data as graphs or tables.

Data can be integrated into a large database and analysis of data from many patients and/or centers can be combined and analyzed.

In some embodiments the methods of the present invention may be carried out by: (a) collecting information from the patient regarding one or more episodes related to the syndrome and (b) analyzing the information by identifying the presence or absence of predetermined patterns in the information. The methods may further comprise providing feedback to the patient based on the analysis. The information may relate to one or more of: the following: (i) the nature, severity, and/or timing of symptoms, wherein the symptoms may comprise one or more clinical indicators; (ii) one or more predisposing factors that are predictive of onset of an episode; (iii) one or more actions related to treatment that have been self-administered by the patient and/or administered to the patient by a surrogate; and (iv) one or more changes in the symptoms, indicators, factors, or actions over time.

In one aspect, the collecting and/or providing step is achieved using a microprocessor having storage means capable of storing the information, an input means, a display operationally connected to the microprocessor, and a means for transmitting the information to a second device; and the analyzing step is achieved using a central computer capable of receiving and analyzing the transmitted information and providing the feedback. In one series of embodiments, the collecting step comprises entry by of the information by the patient using a handheld computer.

In another aspect, the invention encompasses applying one or more rules to the collected information, in order to identify patients requiring particular types of feedback or intervention. The rules may be, e.g., general rules, group rules, or individual rules. Non-limiting examples of such rules include: (i) a specified threshold time interval during which the patient has not reported any data; (ii) a specified threshold time interval from onset of a particular symptom to administration of treatment; (iii) a specified threshold number of self-treatment actions to treat one particular episode; and (iv) a specified clinical outcome of the episode.

In another aspect, the invention encompasses repeating the collecting and analyzing steps in order to further refine and/or develop the rules, which may be modified for a single patient or groups of patients based on repeated collection and analysis of information.

In one series of embodiments, the invention provides a method for assisting in the treatment of a disease, which is carried out by the steps of: (i) collecting from a plurality of patients information relating to symptoms and/or self-treatment of the disease via a handheld electronic device; (ii) transmitting the information collected by the handheld device to a database; (iii) analyzing the data in the database; (iv) providing the results of the analysis to a health care professional treating one of the plurality of patients; (v) receiving from the health care professional a message for the one patient; and (vi) transmitting the message to the one patient's handheld electronic device.

In another aspect, the invention encompasses systems for assisting a health care professional in managing the treatment of a particular patient suffering from a disease, which comprises: (i) a plurality of patient interface devices for collecting data from a plurality of patients, transmitting the data, and receiving instructions relating to treatment of the disease; (ii) a database for storing the data; (iii) an analytic tool for analyzing the data in the database and providing an analysis specific for the particular patient to the health care professional; (iv) a means for receiving from the health care professional a message for the particular patient; and (v) a means for transmitting the message from the health care professional to the patient. The analytic tool may apply a set of rules to the data, which may be modified by the health care professional, the patient, or both.

In another aspect, the systems of the invention may comprise: (i) a memory unit; (ii) a display unit; (iii) an input means; (iv) a communication means for communicating over a network; (v) a processor interfaced with the memory unit, the display unit, the input means, and the communication means, wherein the processor, upon entering an activation mode, is configured to (a) prompt the user to enter data related to the patient's treatment of the disease and (b) store the data in the memory prior to exiting the activation mode; and, upon re-entering the activation mode, is configured to (c) prompt the user to enter follow-up data relating to previously reported data; (d) transmit the data and follow-up data over the network to one or more network addresses; and (vi) an analysis tool having a second processor configured to (a′) receive, from the network, the patient data relating to the patient's treatment of the disease and the follow-up data; (b′) apply a predetermined set of disease specific rules to generate an analysis of the data and follow-up data; (c′) generate a message based on the analysis; (d′) generate, upon request, a report based on the analysis; and (e′) transmit the message over the network. In some embodiments, the message is transmitted to the patient interface device. In some embodiments, the patient interface device comprises a barcode reader and a touch screen.

The system may also comprise a database located at a network location accessible to both the patient interface device and the analysis tool.

In one series of embodiments, the patient interface device may also comprise a drug delivery device, including, without limitation, the ability to deliver drugs to treat hemophilia or diabetes and/or a medical monitor for monitoring one or more specific parameters related to the patient's disease, such as, e.g., blood pressure, blood coagulation, haemoglobin, or creatinine.

In another aspect, the invention encompasses a patient interface device for assisting a patient in the treatment of a disease, which is comprised of (i) a memory unit; (ii) a display unit; (iii) an input means; (iv) a communication means; (v) a processor interfaced with the memory unit, the display unit, the communication means, and the input means, wherein the processor, upon entering an activation mode, is configured to prompt the user to enter data related to the patient's treatment of the disease is configured to store the data in the memory prior to exiting the activation mode; upon re-entering the activation mode, is configured to prompt the user to enter follow-up data relating to a previously reported data; and is configured to transmit the data and follow-up data over the network to one or more network addresses.

In another aspect, the invention encompasses a system for analyzing patient data from one or more patients with a disease, the system comprising: (i) a communication means for receiving data collected contemporaneously with an administration of a self-treatment or an onset of a symptom of the disease; (ii) a processor configured to apply a predetermined set of criteria to the data to generate an analysis of the data and configured to generate a patient message based on the analysis; and (iii) a means for transmitting the message based on the analysis over the network to the patient.

In another aspect, the invention provides an electronic database for assisting in the self-treatment of a disease, which is comprised of: (i) a data element representative of the disease being treated; and (ii) data from a plurality of patients who have the same disease, the data relating to one or more symptoms of the disease and self-administered treatments for the disease that are administered for prevention of symptoms or in response to the symptom(s), the data being collected contemporaneously with the onset of the symptom(s) or the administration of the treatments.

In another aspect, the invention provides a method for assisting in the treatment of a patient with a disease comprising the steps of: (i) recording data related to self-administration of a treatment for the disease or a symptom of the disease contemporaneously with onset of the symptom or the administration of the self-treatment; (ii) transmitting the data over a network to a database that is accessibly by an analysis tool; (iii) analyzing the data with the analysis tool by applying a predetermined set of rules to the data; (iv) generating a physician or care-giver report and/or a patient message based on the analysis; and (v) transmitting the message to the patient over the network.

The present invention provides numerous advantages to both treating physicians and patients. In particular, for example in the field of hemophilia physician and nurses can decrease the time spent reviewing logs, established rules are flexible and adjustable for each treatment center, and feedback to patients about their treatment and use of infusion therapy is improved.

### BRIEF DESCRIPTION OF THE DRAWINGS

FIG. 1 is an illustrative system drawing of one embodiment of the system of the present invention.

FIG. 2 is a screen view for a PPC configured to work with the system of embodiment 1.

FIG. 3 is a screen view illustrating an Infusion Data Electronic Analysis System Icon that may be used to start select the functions of the PPC that enable entry of hemophilia data.

FIG. 4 is a screen view illustrating how the present invention may be used to configure a PPC to collect hemophilia data from a patient.

FIG. 5 is a screen view illustrating exemplary prompts for prompting a patient to enter data into the PPC.

FIG. 6 is a screen view illustrating the barcode entry capability of the PPC.

FIG. 7 is a screen view illustrating barcode data entry.

FIG. 8 is an additional screen view illustrating barcode data entry.

FIG. 9 is a screen view illustrating patient data entry concerning data for infusion reasons.

FIG. 10 is a patient data entry screen for entering follow-up data.

FIG. 11 illustrates a patient data entry screen for inputting additional data.

FIG. 12 illustrates an immune tolerance data entry screen.

FIG. 13 illustrates an additional data entry screen.

FIG. 14 illustrates a graphical interface for entering data related to specific bodily regions.

FIG. 15 illustrates a graphic user input interface for allowing data entry about bleeding in specific graphically depicted body areas.

FIG. 16 illustrates a screen views for prompting patients for complete and follow-up data related to reported conditions and treatments.

FIG. 17 illustrates a prompt screen prompting a user to complete data input.

FIG. 18 illustrates a screen that conveys which required information is missing.

FIG. 19 illustrates a graphical data analysis.

FIG. 20 illustrates expanded data detail views.

FIG. 21 illustrates how data analysis may be exported to spreadsheets or other graphical display means.

FIG. 22 illustrates a log-in screen for a website that allows patient data to be entered.

FIG. 23 illustrates a data entry screen that is useable with a website or handheld device.

FIG. 24 illustrates a data capture screen.

FIG. 25 illustrates a data entry screen adapted for use with a hemophilia treatment system.

FIG. 26 illustrates a multi-patient data flagging report.

FIG. 27 illustrates a screen showing individual patient data records.

FIG. 28 illustrates a pop-up screen that can be used to send patient alerts.

FIG. 29 illustrates a multi-clinic system used to compile large data from different sources.

### DETAILED DESCRIPTION OF THE INVENTION

The present invention provides methods and systems for interactive home treatment of a patient suffering from a disease. The methods are carried out by collecting information from the patient in the form of structured data relating to the disease and analyzing the information in a manner that facilitates appropriate recognition of emergence of care issues and their treatment. The invention further comprises providing feedback to the patient to, e.g., optimize self-treatment, correct inappropriate patient behavior, alert the patient and/or a clinic or medical professional of the need for intervention, or to provide other beneficial actions or outcomes. The invention provides the advantage of a rationalized and personalized home treatment regimen and allows more efficient use of medical resources, including therapeutic treatments and medical professionals' time.

In one embodiment, the present invention may be particularly useful in assisting in treatment of a chronic and/or episodic disease or syndrome. The present invention is particularly useful in treating a disease characterized by a periodic or sporadic appearance of symptoms or fluctuations in severity of symptoms. Non-limiting examples of such diseases or syndromes include diabetes, hemophilia, asthma, chronic liver disease, hypertension, acquired immune deficiency syndrome, multiple sclerosis, rheumatoid arthritis, and other autoimmune diseases, epilepsy, chronic or recurring viral infections (such as, e.g., chronic hepatitis C infection and AIDS), chronic kidney insufficiency with home dialysis, chronic myocardial insufficiency, chronic anticoagulant treatment, Crohn's disease, ulcerative colitis, sickle cell anemia, thallasemia, malaria, chronic substance abuse, cancer, chronic pain syndrome, peripheral vascular disease and the like. While the present invention is particularly well-suited for chronic and/or episodic disease and syndromes, it may be used in monitoring and assisting in the treatment of other diseases as well.

Treatment as used herein encompasses both preventive and therapeutic activities as applied to expected or actual disease episodes, respectively. Illustrative non-limiting examples of preventive and therapeutic actions, respectively, include administration of a coagulation replacement therapy to a person known to be hemophiliac prior to a dental procedure or after bleeding caused by such a procedure; administration of insulin to a person known to be diabetic prior to, or after, mealtime; or administration of a bronchodilator to a person known to be asthmatic prior to exercise or after occurrence of symptoms caused by exercise. Home treatment refers to an action that is performed by an individual at a location removed from one at which professional medical treatment is normally administered, such as, e.g., a hospital, clinic, or doctor's office. Thus, home treatment may take place at home, work, or school, as well as during leisure activities, travel, and the like. Home treatment encompasses any action taken by the patient (i.e., self-administration) or by a surrogate, such as, e.g., by a parent for a child or by any other person acting on behalf of the patient.

### Collection of Structured Data:

In practicing the present invention, data are collected from the patient that are relevant to the patient's chronic condition and that may relate specifically to a current episode of the condition. The collecting step may be achieved by direct input from the patient and/or by input from a surrogate.

Typically, the data being collected encompass at least one, and preferably more than one, of the following categories of information: (i) the nature, severity, and/or timing of symptoms, including one or more clinical indicators; (ii) one or more predisposing factors that are predictive of onset of symptoms; (iii) one or more actions related to treatment that have been self-administered by the patient and/or administered to the patient by a surrogate; (iv) treatment-specific information such as type and amount of product used and batch number of product (v) one or more changes in the symptoms, indicators, factors, or actions over time; and (vi) patient assessment of response to treatment. Optimally, data collection occurs contemporaneously with the onset of symptoms or predisposing factors, the taking of action, or the occurrence of changes as described above. As used herein, “contemporaneously” refers to a time interval that is short enough so that (i) the data being collected can be used in practicing the invention or (ii) the data being collected are accurately recalled by the patient. For example, in some embodiments, the data relating to an episode are collected (and transmitted, see below) sufficiently rapidly after the onset of symptoms to allow for timely feedback (see below) that can be helpful to the patient. In other embodiments, the data being collected are used to compile a database.

As used herein, a “symptom” refers to any indication of onset of disease that is apparent to the patient or a surrogate. A “clinical indicator” encompasses an indication of disease onset that relies on a measurement, such as, e.g., body temperature, blood or peripheral glucose levels, blood hemoglobin, pain in a muscle or joint, circumference of a joint or muscle, angular movement of a joint, plasma bilirubin, or plasma creatinine A “predisposing factor” refers to any actions or circumstances that are associated with onset of symptoms, such as. e.g., food intake associated with hyperglycemia in a diabetic; injury, exercise or surgical procedures associated with bleeding in a hemophiliac; exercise associated with bronchoconstriction in an asthmatic; and the like. A “change” refers to any difference perceived by the patient or any detectable difference in a clinical measurement.

It will be understood that the particular types of data to be collected from a patient will depend on the particular syndrome, condition, or disease from which the patient suffers. It will be understood that, for a particular syndrome, the types of data to be collected and the way in which such data are structured can be determined using ordinary skill in light of the guidance provided herein.

In some embodiments, the disease being treated is hemophilia and the structured data may include, without limitation, the physical origin of a bleeding episode; the severity and timing of bleeding; the amount and timing of self-administration of coagulation replacement therapy; the time to arrest of the bleed, and other details of how the bleeding episode was resolved. In other embodiments, the disease being treated is diabetes and the structured data may include, without limitation, blood glucose levels at different times; the amount and timing self-administration of insulin or other antihyperglycemic agent; and the patient's dietary habits, i.e., specifics of food intake. In yet other embodiments, the disease being treated is asthma and the structured data may include, without limitation, the severity and timing of wheezing, the forced expired volume, and the amount and timing of self-administration of anti-asthma medication. In yet other embodiments, the disease being treated is chronic liver disease and the structured data may include, without limitation, plasma liver enzymes measurements. In yet other embodiments, the disease being treated is renal disease with home dialysis and the structured data may include, without limitation, plasma creatinine measurements. In yet other embodiments, the disease being treated involves chronic anticoagulant treatment and the structured data may include, without limitation, prothrombin time.

In practicing the present invention, the collecting step is achieved using any local collecting device capable of receiving the information from the patient and, preferably, conveying the information to another location. Such collecting devices typically contain a programmable microprocessor and/or a storage means capable of storing the information. Non-limiting examples of collecting devices include personal computers, personal digital assistants or pocket personal computers (“PDA” or “PPC”), telephones (preferably wireless), and “smart devices” (including, without limitation, devices that incorporate clinical monitors—such as, e.g., devices that monitor blood glucose, hemoglobin, liver enzymes or bilirubin, or blood pressure—or devices that deliver drugs or therapeutic agents—such as smart injection devices, drug delivery pumps or inhaler, and the like.) Preferably, the collecting device is portable and includes a display feature that facilitates input of the information.

The information to be collected may be entered into the collecting device by any means known in the art, such as, e.g., manually, using a keyboard or a touch-screen, or automatically, e.g., using a scanner, bar-code reader, and the like. The information may also include data that is entered directly from a “smart device”.

The collected data are then conveyed electronically (e.g., via phone lines, cellular, wireless, or satellite networks, or the Internet) to a computer that is programmed to perform the data analysis. In some embodiments, the data are first conveyed to centralized core system, such as, e.g., a database stored in a Web hotel, after which data relating to a particular patient are conveyed specifically to the clinic or medical office with which the patient is associated.

In other embodiments, the data are conveyed directly to the clinic or medical office. The data analysis may be performed at any appropriate location, including, without limitation, the centralized core system or the clinic, with the proviso that the results of the analysis should be available to be provided to the patient, preferably in electronic form.

### Data Analysis:

According to the present invention, clinical information obtained from the patient relating to self-treatment, i.e., of a chronic and/or episodic disease, is analyzed to identify the presence or absence of predetermined patterns that indicate the need for some type of intervention (which may also be carried out using the system of the invention.) Such interventions include instructions to the patient to modify the patient's self-treatment regimen, such as, e.g., by instructing the patient to perform a certain action or to refrain from a certain action, or by instructing the patient to seek immediate treatment by a medical professional. In some circumstances, the intervention may include a contact to the patient initiated by the medical professional in the absence of any direct request from the patient.

The analysis is conducted using one or more rules. A rule refers to a single criterion, or a set of criteria, that identifies a predetermined pattern in the data being collected, wherein the pattern has been correlated to a need for certain actions or decision-making, whether on the part of patient or a medical professional. Such rules may be disease-specific (i.e., generally applicable to anyone suffering from a particular disease); group-specific (i.e., applicable to a subset of patients suffering from that disease who, further, fulfill certain criteria related to symptoms, behavior, etc.); and/or patient-specific (i.e., tailored to an individual patient, based on the disease state, treatment regimen and the patient's personal history of, e.g., symptoms, behavior, and the like).

For example, a disease-specific rule may identify a particular symptom that is known to indicate that any patient reporting that symptom, rather than attempt self-treatment at home, instead should contact a medical professional (e.g., call a doctor, go to clinic or emergency room, etc.). Similarly, group-specific or patient-specific rules may identify particular symptoms or behaviors as indicating a need for a particular intervention, whether by the patient or by a medical professional.

This analysis, specifically the application of general, group-specific, and individual-specific rules to the patient-entered data, results in the generation of responses which are accessible to the patient and/or to a medical professional involved in the patient's care.

For example, in the case of patients suffering from hemophilia, the following non-limiting criteria may be used to identify episodes in which the patient should not rely on self-treatment but should instead be contacted by a medical professional: (i) the interval in which the patient has not reported any data (i.e., has not collected any data according to the invention); (ii) the proportion of total bleeds that is attributed to a single joint or body location; (iii) a threshold number of bleeds in a given time period; (iv) the average time from onset of bleed to self-treatment; and (v) a threshold number of self-treatment infusions to treat one particular episode. (See, Example 1 below).

### Feedback:

In practicing the present invention, responses are fed back to the patient and/or medical professional, preferably immediately and preferably electronically. The responses are preferably conveyed by the patient via the same local device that was used by the patient to input the data. The responses may also be conveyed to the clinic at the same time. Cumulative data for a particular patient may be stored in a database in a centralized core system and/or in a database at the clinic.

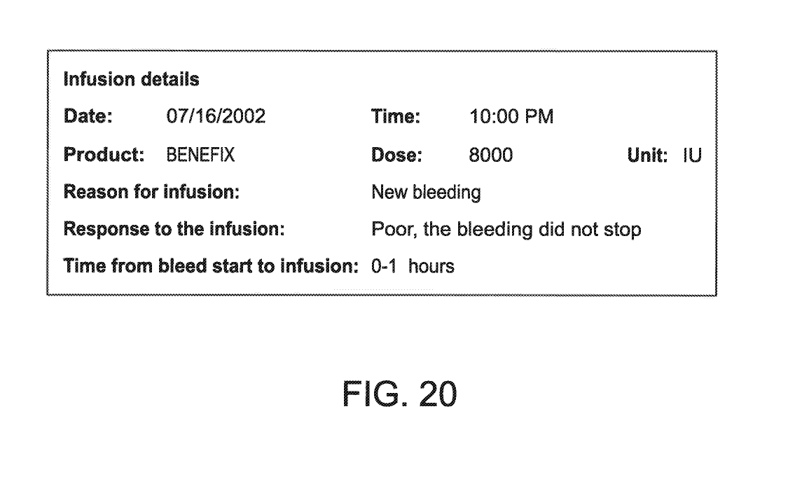

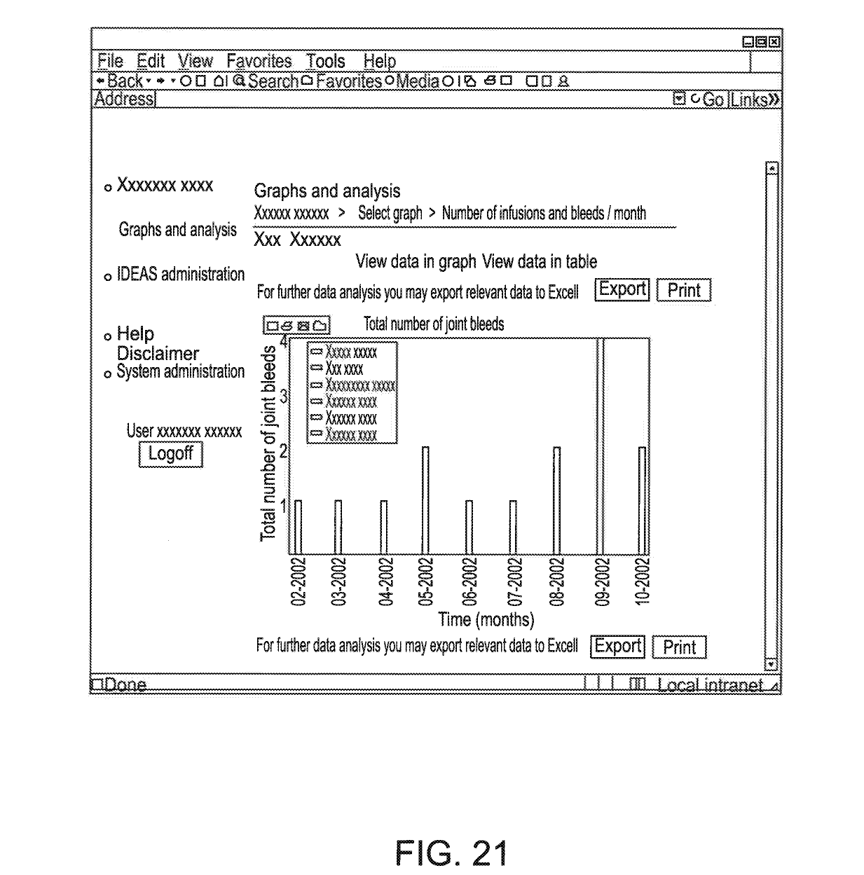

As is shown Figure in 19, a graphical view may be used to show, for example hemophilia infusion data. Infusion data, or other data, may be graphically viewed for an individual patient, groups of patients, and/or a particular product. Individual data, such as individual infusion data, may be expanded to view details, as is shown in FIG. 20. Moreover, established output graphs may be used to make viewing of the majority of important issues regarding analysis of infusion data.

Additional advantages of the present invention include the ability to easily export data to spreadsheets, such as Microsoft® Excel®, for further analysis outside of established output functions.

Additionally, clients utilizing the system can be given access to some graphic infusion data analysis through personalized secure websites. For example, a patient website can be established in which the patient can view their own data. The data may include data inputted by the patient, as well as data inputted by a clinic. A third party medical practitioner can also be given access to the data. A particular advantage of the present invention is that both clinical data and patient inputted data can be stored at one location, manipulated, and analyzed, thereby aiding a practioner in optimizing a treatment regimen for a particular patient.

In addition, the ability to view both the patient-inputted data and the clinic-inputted data can allow for pharmacoeconomic studies to be done on a patient-by-patient basis as an approach to optimize treatment. Additionally, the viewing of both types of data can be used to detect and correct non-compliance of a treatment regimen by a patient.

As the data often contain private medical information, security is an issue. Some security measures within the scope of the present invention include:
1) entering data into the PPC with a username and password;
2) entering the data into a website with a username and password;
3) encrypting and otherwise securing transmission of the data;
4) allowing each center to have exclusive access to their patient data; and
5) Allowing the client and only the treatment center the ability to access the data, unless the client grants rights to a third party.

### Iterative Analyses and Development of Rules:

In some embodiments, the present invention encompasses repeated applications of the above-described method, i.e., repeated steps of collecting patient-entered data and analyzing the data using rules (with or without the step of feeding back to patient the results of the analysis). It will be understood that such iterative application of the methods of the invention can be used to detect additional patterns of correlation between, e.g., particular symptoms or patient behavior and particular clinical outcomes. Such patterns then become useful to develop and refine additional disease-specific, group-specific, and/or patient-specific rules.

In one aspect, the present invention encompasses methods for the development of rules that can be used for data analysis as described above. The methods are carried out by the steps of:

(i) collecting from a plurality of patients suffering from a particular chronic and/or episodic syndrome patient-specific and episode-specific data, wherein the data relate to one or more of: (a) the nature, severity, and/or timing of the patient's symptoms, including one or more clinical indicators; (b) one or more predisposing factors that are predictive of onset of symptoms for that patient; (c) one or more actions taken by the patient related to treatment that have been self-administered by the patient and/or administered to the patient by a surrogate; (d) one or more changes in the symptoms, indicators, factors, or actions over time following initial onset of an episode, to create a patient database; and (e) patient assessment of response to treatment;

(ii) establishing correlations between one or more of (a)-(e) and the outcome of the episodes, wherein the outcome involves resolution, continuation, development, or other change in the symptoms; and

(iii) identifying actions taken or not taken by the patient or a medical professional that were helpful or deleterious in achieving resolution of the symptoms; and

(iv) repeating steps (i)-(iii) above to provide predetermined patterns.

In one series of embodiments, the predetermined patterns that are derived from the above analysis may identify different sub-categories of patients that exhibit particular symptoms and/or respond to particular interventions, thereby creating group-specific rules.

In another series of embodiments, the above method may be used to customize rules for a particular patient. In these embodiments, (i) data are collected from a single patient relating to a plurality of episodes; (ii) correlations are established between and among the collected data (such as, e.g., a correlation between the interval between occurrence of a particular symptom and the outcome of the episode), as well as between the patient-specific data and larger patient databases. (The larger patient databases to which the patient-specific data are compared may comprise, without limitation, the entire population of patients suffering from the disease, or, alternatively, a sub-group of patients previously identified using the methods of the invention.) In this manner, the rules are modified to provide a more tailored feedback protocol applicable to that particular patient. For example, with one particular patient, the appearance of a particular symptom may signal the need for that patient to be contacted by a medical professional immediately, whereas, in another particular patient, the number of individual episodes occurring within a particular time period may signal that same need.

In another series of embodiments, the methods of the invention may be used as an important part of an ongoing analysis of resource utilization by a particular patient or group of patients suffering from a similar disorder.

It will be understood that correlations and patterns may be derived from conventional statistical analyses well-known in the art, with or without input from medical or other professionals relating to anecdotal or other insights or expectations of disease mechanisms and patient behaviors.

It will also be understood that a rule developed using the methods of the invention may be further validated by testing if application of the rule to specific collected data results in (i) the identification of, e.g., problematic patients or episodes (ii) more successful resolution of an episode or episodes, (iii) reduction in the number of episodes in a particular patient or in a group of patients and/or any indication of better clinical management of disease in a particular patient or in a group of patients. Such testing may be followed by repeating the above steps in order to further refine a particular rule.

While some situations call for a complex set of rules, simpler flagging rules may, in certain cases, be adequate. For example, the following rules have shown to be adequate in assisting in the self-treatment of hemophilia. The bracketed values may be modified by an individual center.

Rule 1. No reporting from patient in {30 days}

Rule 2. The number of joint bleeds in one location exceeds {25%} of total number of bleeds (for the last six months).

Rule 3. The total number of bleeds exceeds {4} during a period of 30 days.

Rule 4. The average time from onset of bleed to infusion exceeds {3 hours} (average for the last six months)

Rule 5. More than {2 infusions} for one particular bleed

A “please call center” message is generated and sent to the patient. In addition, pop-up boxes may be used to communicate critical information to a patient.

### Systems for Interactive Home Treatment

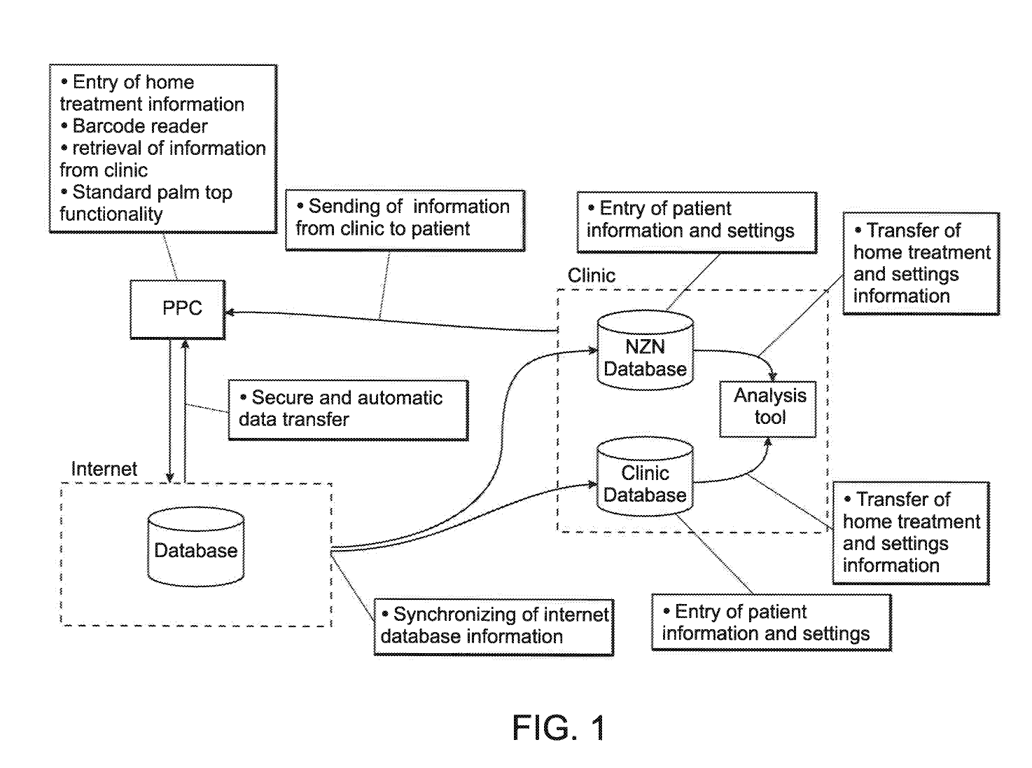

As is shown in FIG. 1, the system of the present invention may include a patient interface device, such as a Pocket Personal Computer (“PPC”). The PPC may be any intelligent portable device, including—but not limited to—a personal digital assistant, a programmable cellular phone, a smart medical device (such as a drug delivery device or a medical monitor), or any other portable device that has a processor and memory, an input means, a display means, and a communication means. Preferably, the PPC is a handheld electronic device with bi-directional communication capability. It may have wireless communication capabilities or it may have an interface for connecting it to a standard wired network, existing phone system, LAN, WAN, or the like.

The processor is preferably capable of being programmed to prompt the user for certain information and to input certain data related to that information via the input means, process the data, and store the data locally, at least temporarily, and then transmit at least a portion of the information inputted by the patient to another location. In one embodiment, the PPC may be a standard personal digital assistant running on the Window CE software, such as, e.g., HP jornada 560 personal digital assistant (Product no: F2915A version ABA A1Q3 using Windows CE ver. 1.0-1.1) or a Compaq iPAQ Pocket PC (Product no:269808-021, Model 3950 (S/N:4G26KVL1Y9PH Compaq) using Windows CE version 1.0-1.1)

The input means may comprise a keyboard, a barcode reader, a microphone and associated speech recognition software, or any other mechanism for allowing data to be entered by the patient.

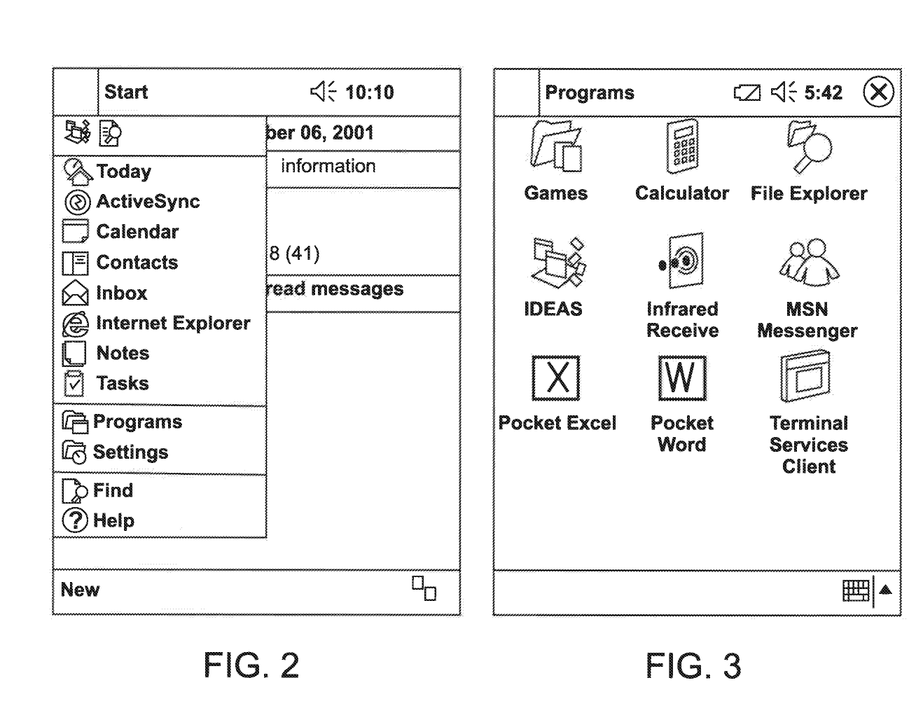

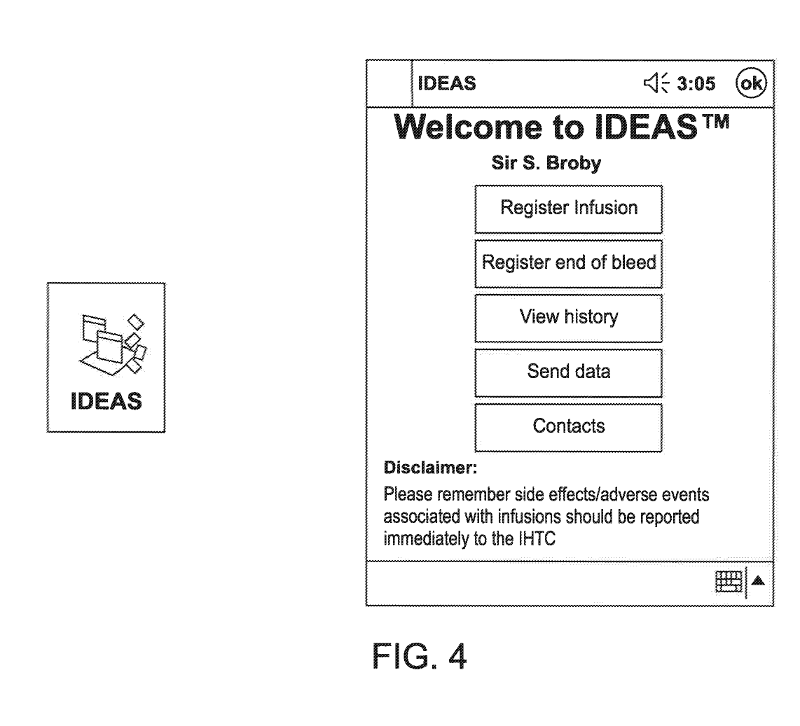

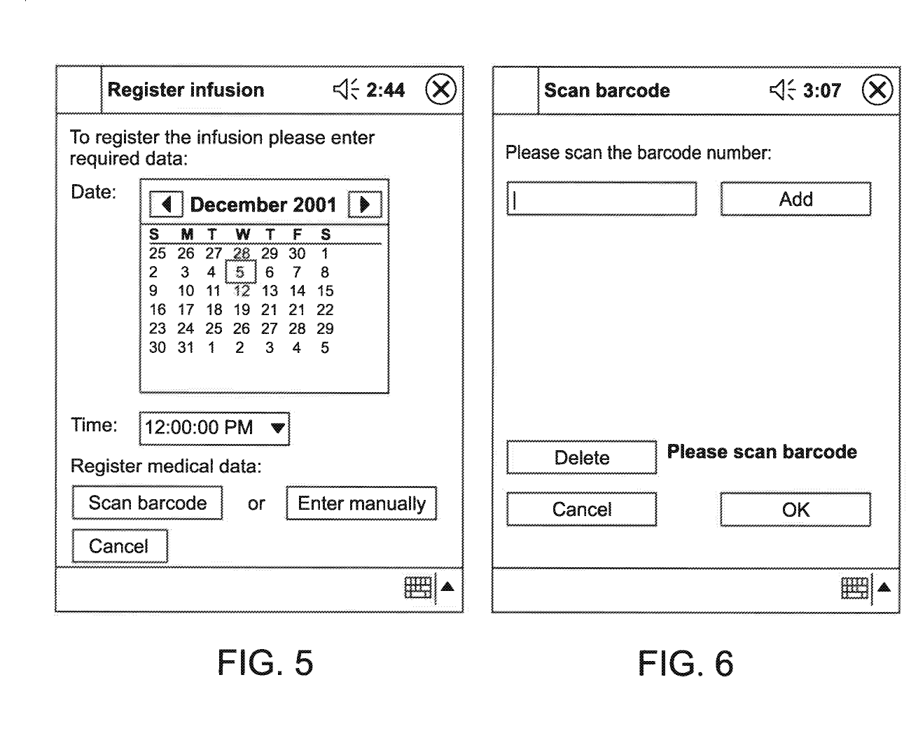

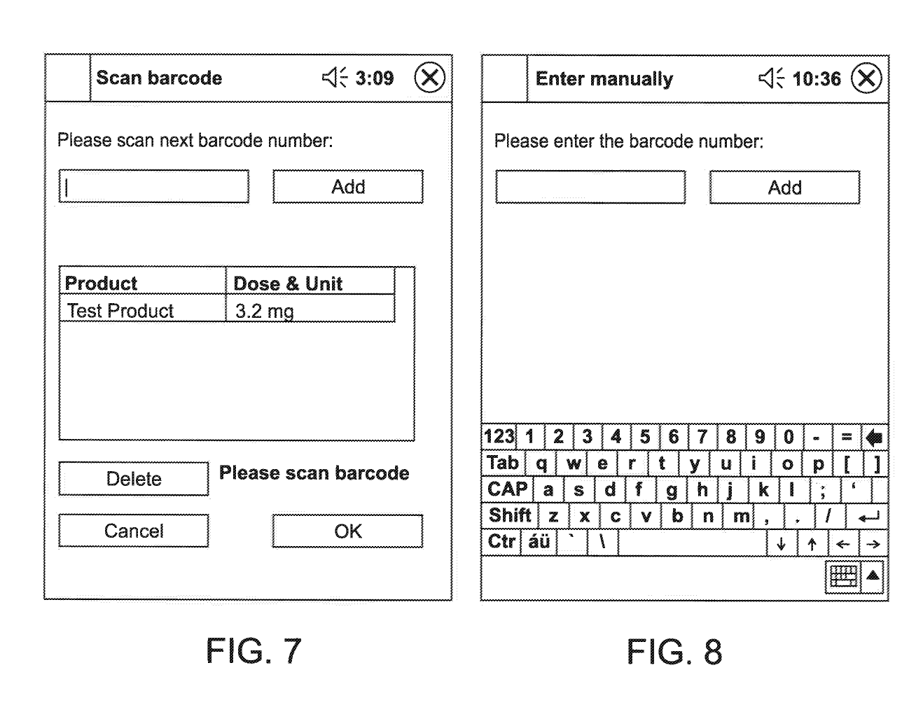

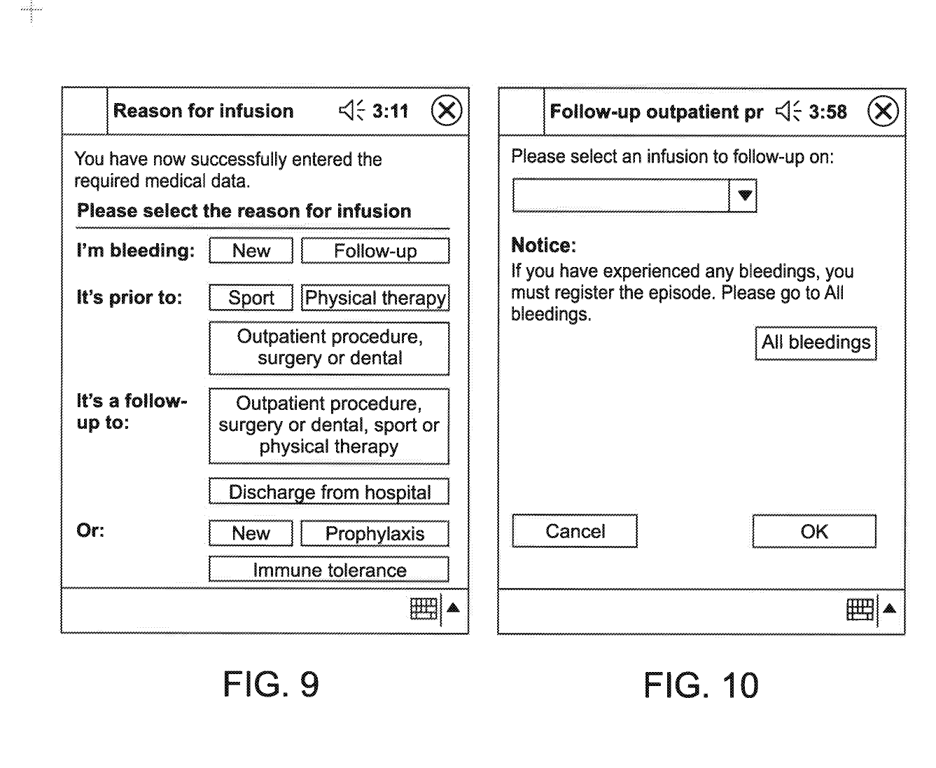

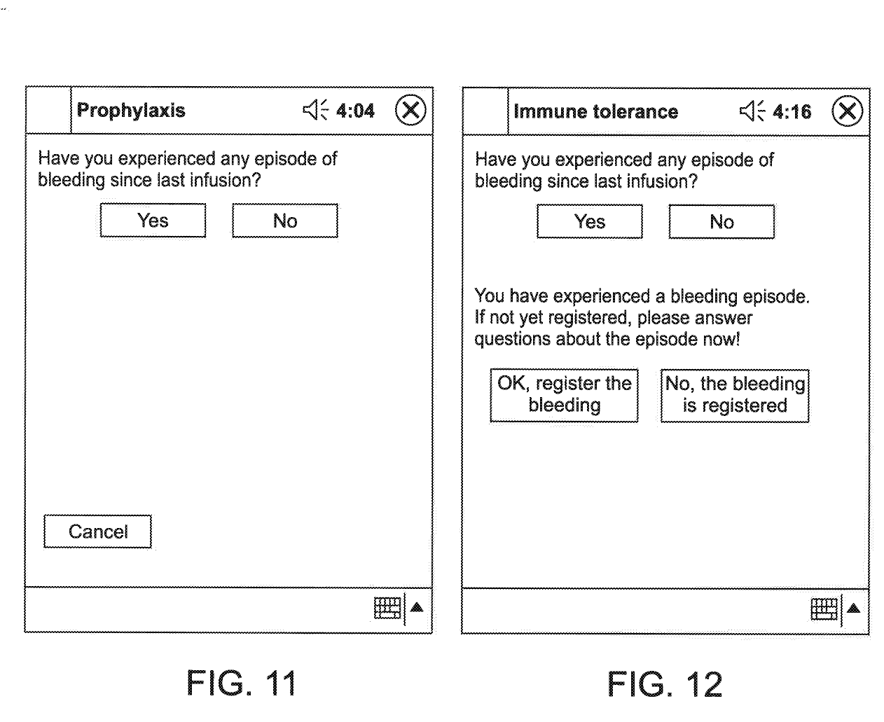

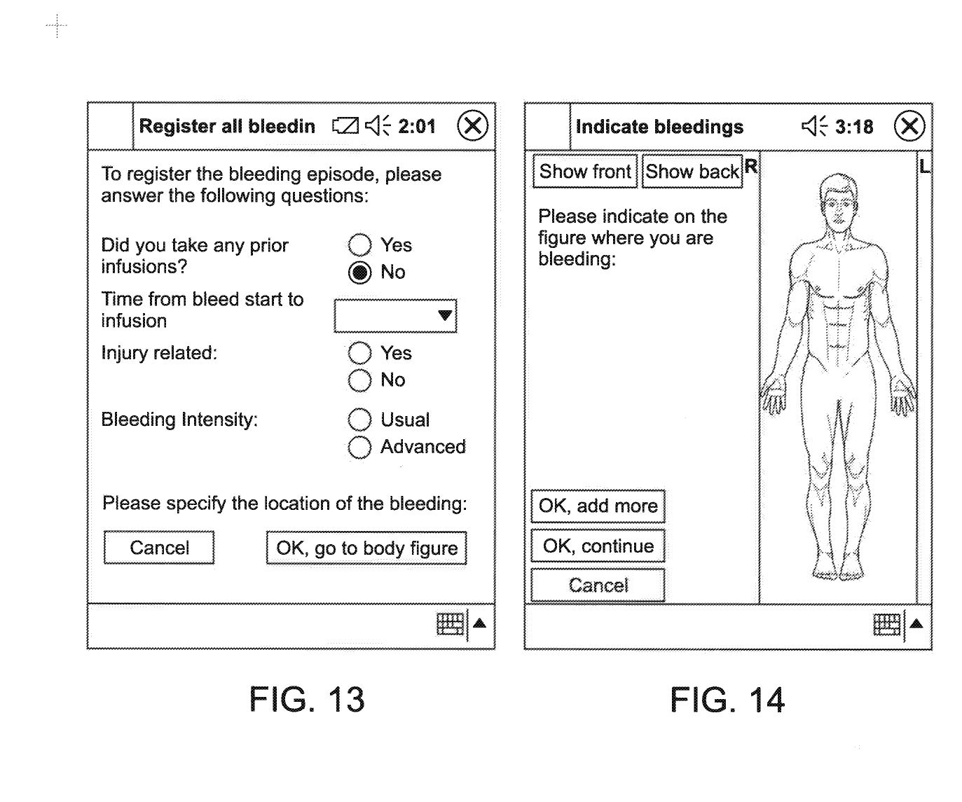

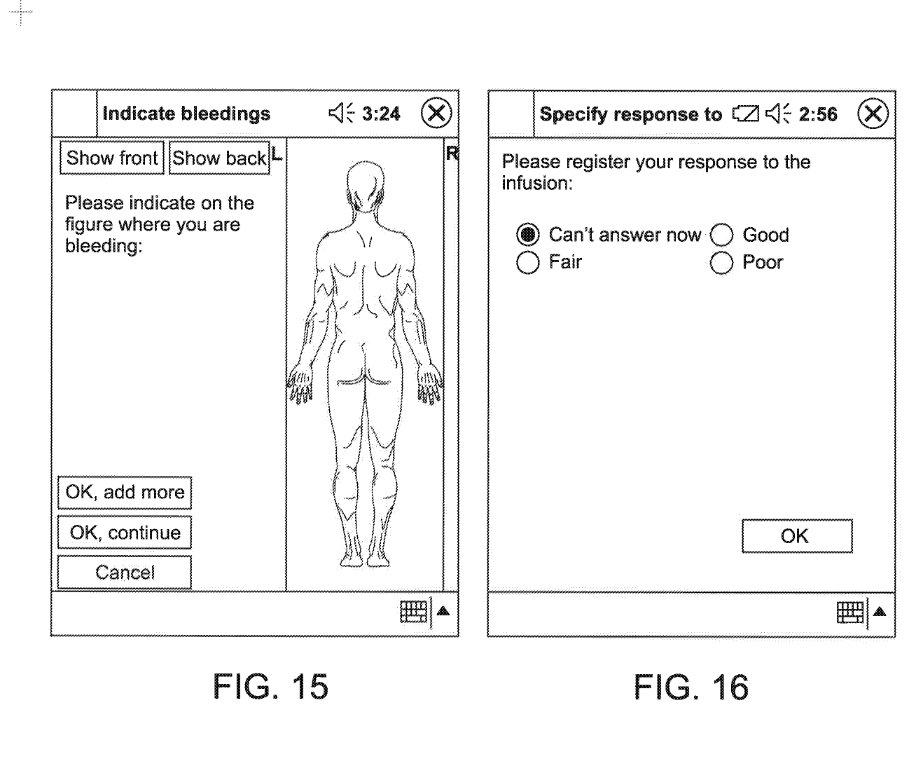

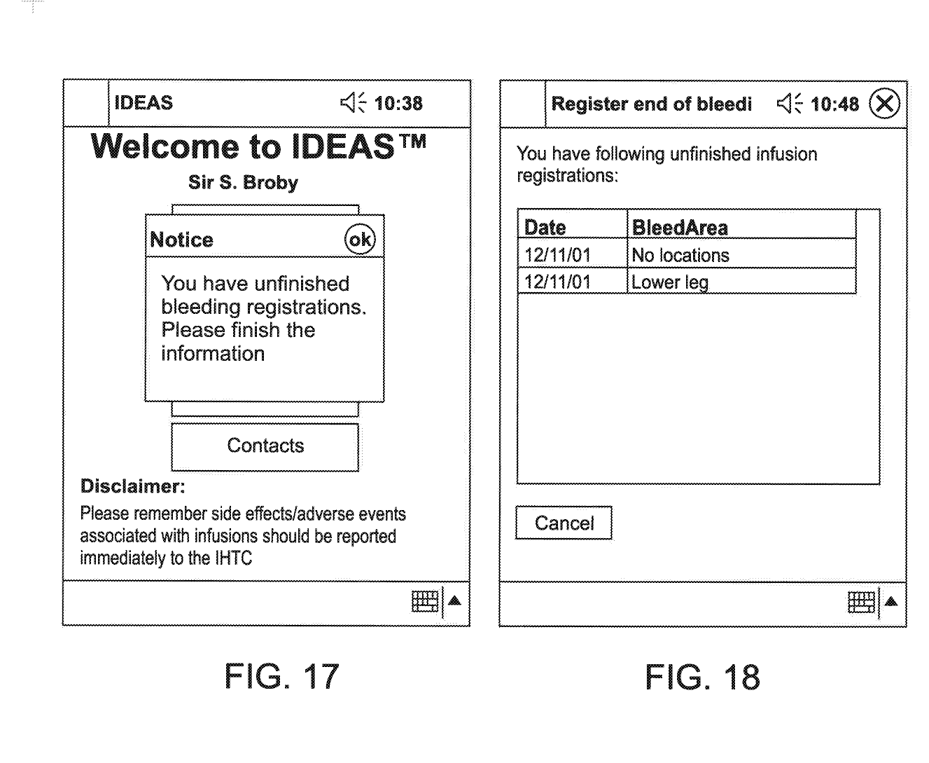

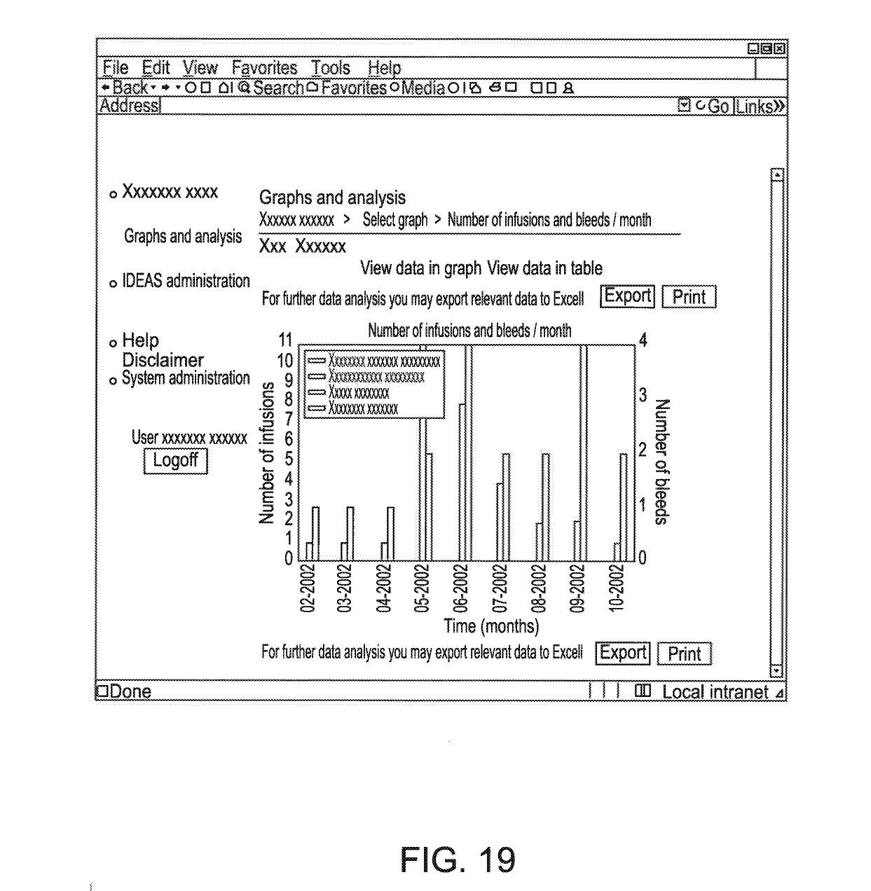

In some embodiments, the input means may include a graphic user interface. For example, where the device is configured for use in the self-treatment of hemophilia, the PPC may be configured to display various body parts. A user experiencing a bleeding episode may be prompted to select the bodily area where a bleeding episode is occurring by touching a screen having a depiction of the human body. FIGS. 2-18 illustrate some examples of screen views for a PPC configured to assist in the treatment of hemophilia. Of course, the PCC may be configured allow for user-friendly inputting of data relevant to other diseases that are to any extent self-treated. Attached as Appendix 1 is an example of a user manual for a PPC programmed to assist in the treatment of hemophilia.

The PPC preferably communicates with a database over a network, such as the Internet. In one embodiment, the communication is performed in a secure manner using encryption technology or other means for secure transmission over public networks. The database may be located at a Web-hotel or other facility. In some embodiments, as is shown in FIG. 1, at least a portion of the database is reproduced and stored at a clinic or other treatment facility. The local database at the treatment facility may be accessed by an analytic tool. The analytic tool may be any conventional PC or any device that may be programmed or otherwise configured to process and/or manipulate the data in the database. A personal computer is particularly well suited for use as an analytic tool, such as, e.g., an IBM Personal Computer 400 GL (166-megahertz or higher Pentium-compatible CPU and 4 megabyte Ram, 128 or more RAM and 2 GB or larger hard disk using the Microsoft Windows 2000 professional UK version operating system. The analytic tool may physically reside in a treating professional's clinic or offices. However, the exact location of the tool is not critical. For example, in some embodiments, the analytic tool may reside within or under the control of an entity with a relationship with the treating physician, such as for example, the IT department of a pharmaceutical company.

Where the analytic tool is not physically located at the treating professional's location, the treating professional may access the tool via a network such as the Internet. Thus, the analytic tool may be web-enabled allowing a treating physician or other health care professional to access the tool from virtually anywhere. One of the many advantages of web-enabling the system of the present invention is that a physician who sees patients in both an outpatient clinical setting or private office can access the tool in that setting as well as when administering to patients in a hospital. The analytic tool, regardless of where it resides, may be programmed to apply the predetermined rules to the data. In some embodiments, the analytic tool is also configured to allow a health care professional to modify the rules based on specific needs and/or experiences of a particular patient.

In an embodiment of the present invention, one or more sets of rules are developed to analyze the data collected by the analytic tool. If certain conditions, as defined in the rules, are satisfied, a message is sent either to the health care provider or directly to the patient. In one embodiment, where the message is sent to the health care provider, the health care provider may create a message and utilize the infrastructure of the system of the present invention to send a message to the patient via the patient's handheld device. The message might be a detailed message for self-administering treatment or it may be a simple message such as “Call Doctor.”

The analytic tool is preferably configured to allow modification to the set or sets of rules by one or more treating healthcare professionals. Typically, default rules will be initially applied to the data, but over time they may be modified based on particular experiences of the patients and the treating professionals. By allowing the rules to be modified as experience is gained with a particular patient or group of patients, the tool may assist in developing a baseline for a particular patient, comparing that baseline against similarly situated patients, modifying the particular patient or group of patients treatment and/or behavior, and more allow for more effective management and treatment of the disease.

In some embodiments of the present invention, a patient website may be used in addition to a PPC or in place of a PPC. The website advantageously allows the patient to view the patient's own data and also allows the patient to input additional data. The website may be secured so that it may only be accessed by the patient, a clinic and/or a medical practitioner authorized by the patient. Additionally, the site is preferably secured with a password or other well-known security technologies and encryption may be employed before data are sent over a public network.

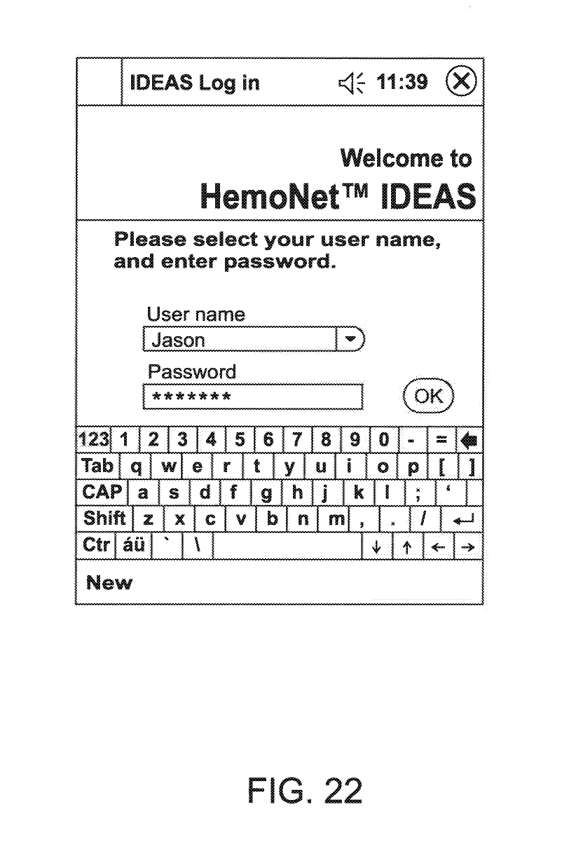

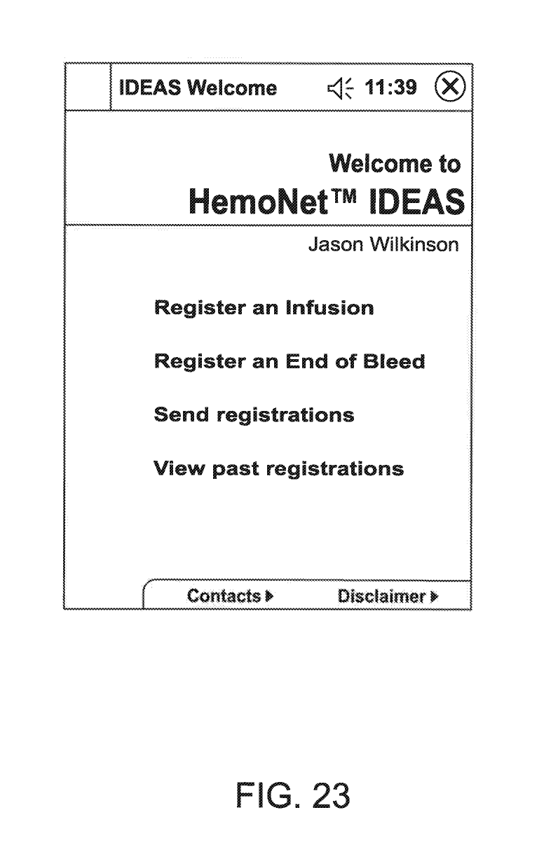

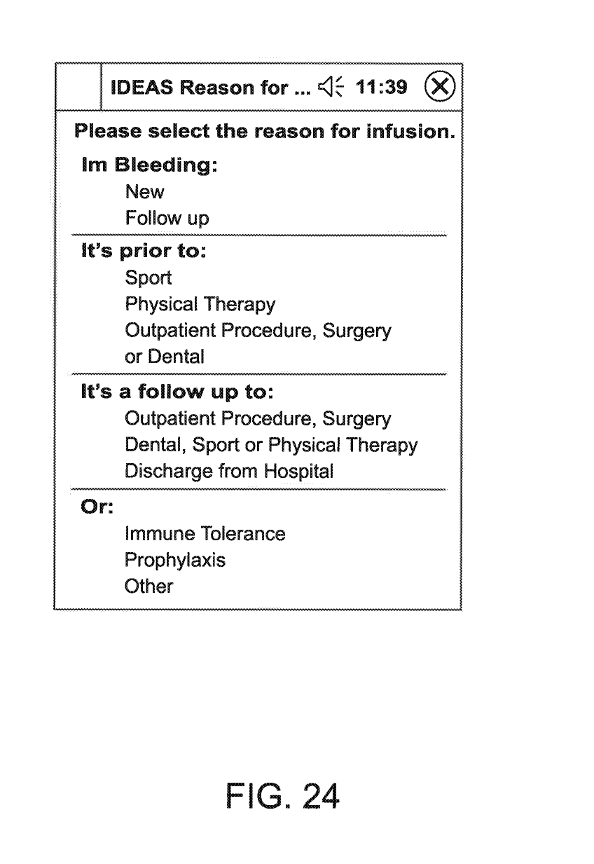

FIG. 22 shows a log-in screen for a web-enabled system that incorporates password and encryption protection. FIG. 23 shows one example of a data entry screen for use with either the PPC or the website based embodiments. Data may be analysed to determine the number of injury related infusions, severity of bleeding event, time from bleeding to institution of infusion therapy, etc. FIG. 24 shows that the present invention also may provide a means for a patient to input data related to assessment of a response to each infusion or an overall bleeding episode, for example, when the system is applied to hemophilia.

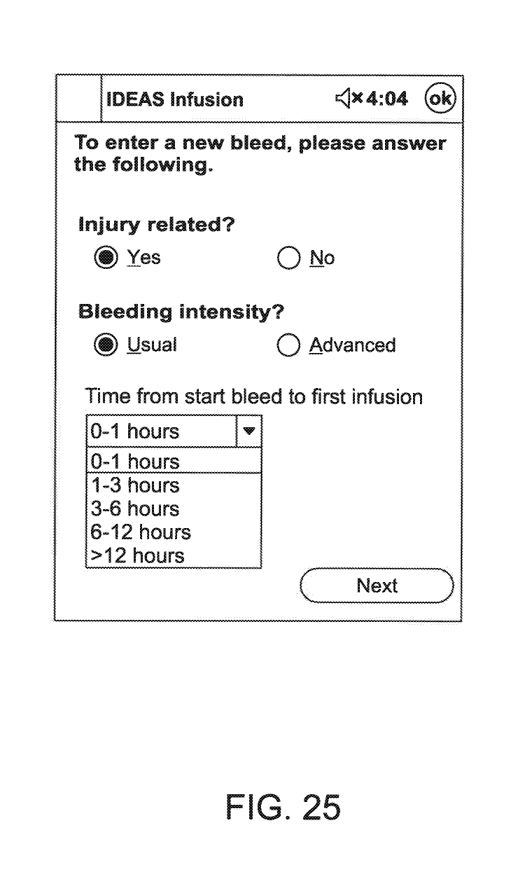

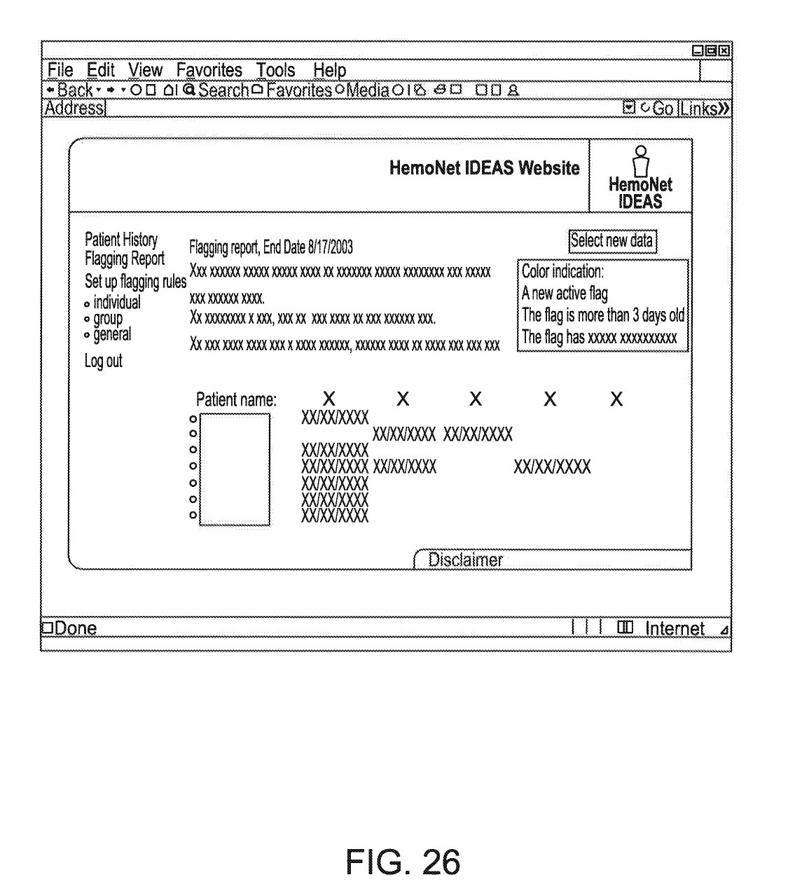

FIG. 25 shows a screen that may be used on either the PPC or a website for facilitating data entry and FIG. 26 depicts a data capture screen that allows linkage of data to events, procedures or treatment plans that allow for pharmacoeconomic analysis. The data may be analyzed to determine compliance with treatment regimen or intervention plans. For example, FIG. 26 shows how transmitted data are analyzed on an ongoing basis by comparison and determination of deviation from established rules. The system rules are easily adaptable to each treatment centers practice and standards of care. Data are typically flagged when they are outside of established parameters and flagged data are easily visible and allow treatment center staff to communicate to the client.

Advances in software and Internet technology make it possible to run the patient client software not only on a PPC or similar device, but also on a centralized server. For example, Microsoft dot.net applications allow the software to be web-enabled. This, in some embodiments, allows for less robust patient-client devices to be used. It also allows the patient to access the patient client software via any device capable of communicating and operating on a network on which the server containing the patient-client software resides. Thus, in some embodiments, the patient only needs access to the Internet to use some of the systems and methods of the present invention.

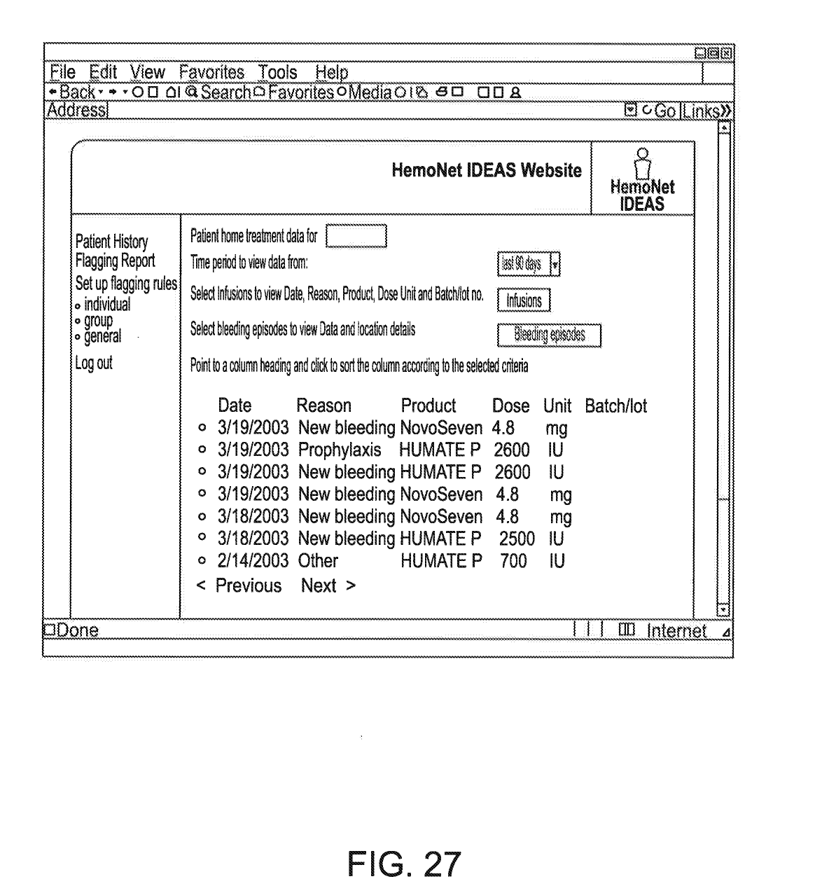

In addition, as shown in FIG. 27, individual patient infusion records may be viewed as abbreviated episodes.

Additional advantages and capabilities of the present invention are too numerous to list herein. However, these advantages and capabilities will be readily apparent to those skilled in the art. For example, and without limitation, when the present invention is utilized in the field of hemophilia care:

data can be analyzed on an ongoing basis by comparison, and determination of deviations from established rules can be analyzed;

system rules can easily be adapted to reach treatment centers' practice and standards of care;

data can be flagged when they are outside established parameters; and flagged data are easily visible and allow treatment center staff to communicate with the client.

Moreover, flagging rules can be used to provide automated messages to both the patient and the patient's healthcare provider. In response to these messages, additional steps may be taken by either the patient or the healthcare provider. As a result of this early intervention, treatment may be modified and optimized and, in some cases, lengthy or expensive hospital based or clinic based intervention can be avoided. Thus, the present invention provides a means for reducing long term medical expenses while optimizing home treatment.

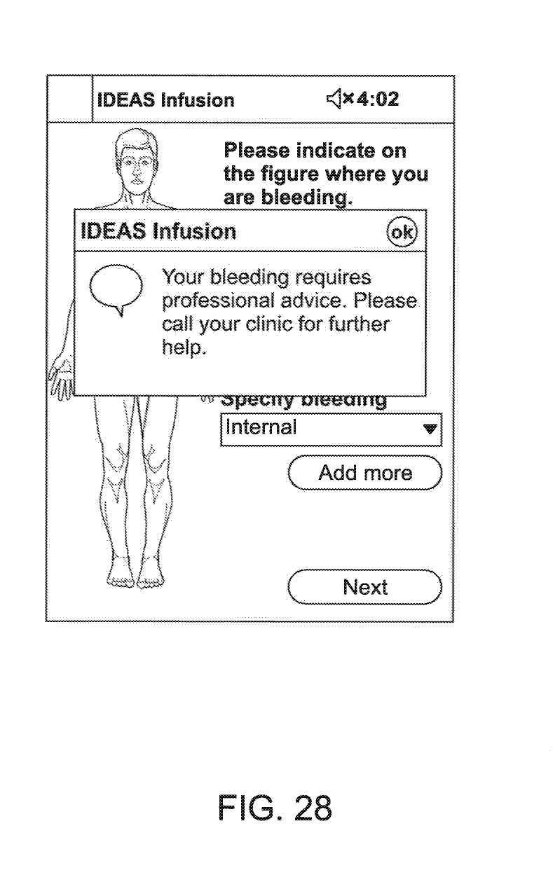

In addition patient alerts can be used to notify patients when a condition requires medical treatment from qualified professionals. FIG. 28 shows how a pop-up box can be used to provide this alert.

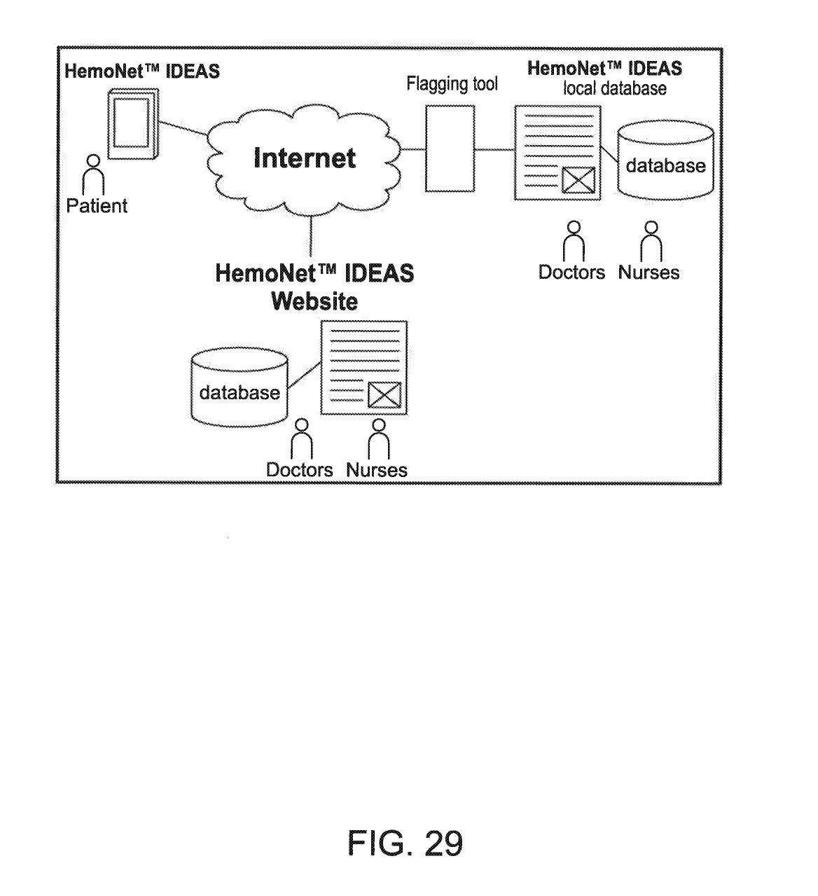

A particularly useful feature of the present invention is that data can automatically be stored within a network environment from different patients and clinics. Patient folders can be established for each patient. And these folders may be automatically integrated into a larger database. FIG. 29 shows one such embodiment illustrating this novel advantage of the present invention.

All patents, patent applications, and literature references referred to herein are hereby incorporated by reference in their entirety.

Many variations of the present invention will suggest themselves to those skilled in the art in light of the above detailed description.

As discussed above, the present invention greatly improves treatment, patient quality of life and the ability to do research and in particular, perform pharmacoeconomic studies such as those described in H. Ekert et al. “Cost-utility analysis of recombinant factor VIIa (NovoSeven®) in six children with long-standing inhibitors to factor VIII and IV Haemophilia (2001), 7,270-285; Economic Costs of Diabetes in the U.S. in 2002, American Diabetes Association Diabetes Care, volume 26, number 3, March 2003; and Isaac Odeyemi, Julian Guest, Modelling the economic impact of recombinant activated Factor Vii and activated prothrombin-complex concentrate in the treatment of mild to moderate bleed in adults with inhibitors to clotting Factors VIII and IX at a comprehensive care centre in the UK, Journal of Medical Economics, 2002; 5:0-0; the contents of all three are hereby incorporated by reference.

The following examples are intended as non-limiting illustrations of the present invention.

### Example 1

### Rules for Interactive Home Treatment of Hemophilia Patients

The following describes the development and application of rules for use of the present invention by patients suffering from hemophilia who, in response to bleeding episodes or for prevention of bleeding episodes, self-administer Factor VIII, Factor IX, or bypassing products in patients with inhibitors.
I. The following rules were used:
   1. An interval of at least A(=7) days since the patient last entered data using the system of the invention.
      (The purpose of this rule is early detection of patients not complying with reporting obligations.)
   2. The number of joint bleeds in one location exceeds B(=20)% of total number of joint bleeds.
      (The purpose of this rule is to detect early target joint development.)
   3. The total number of bleeds exceeds C(=4) during a period of D (=30) days.
      (The purposes of this rule are (i) detection of “break-through” bleeds in patients on prophylaxis regimens and (ii) early detection of changes in patient's disease activity/life style.)
   4. The average time between the onset of a bleed to infusion exceeds E (=180) minutes.
      (The purposes of this rule are; (i) to reveal suboptimal resource utilization and (ii) to prevent target joint development.)
   5. More than F (=6) infusions were self-administered to treat one particular bleed.
      (The purposes of this rule are: (i) to reveal a patient's misinterpretation of his/her clinical situation and (ii) to detect habits of overtreatment.)
   6. Particular sites of bleeding
      (The purpose of this rule is to insure that bleeding in certain sites results in a call by the patient to the treatment center.)
II. Data was collected from a group of 10 patients over a period of two months. Data was analyzed using Anova Multiple Regression Analysis software. Patients were also differentiated by their clinical situations, i.e., patients having coagulation factor inhibitors; patients requiring on-demand treatment, and patients employing prophylactic coagulation factor VIIa self-administration.
III: After two months, the value of A was calculated as the optimal time interval for the system to detect variant behavior as early as possible using multiple regression analysis of pooled patient data. Regression analysis between the total amount of product infused and the time from onset of bleed to infusion in pooled patient data revealed a deviation from a straight line which allowed estimation of the value of E.

Regression analysis of patients developing target joints and of patients not developing target joint compared to the % bleeding intensity in one particular joint allows for optimal estimation of values of B. The observation time could be several months to several years.

Similarly, regression analysis of patient developing progressively intensive bleeding manifestation and patients having a constant bleeding frequency level allows for calculation of the total number of bleeds C over a fixed period of time D that will represent the diversion value between the two modes of disease development.

All patents, patent applications, and literature references referred to herein are hereby incorporated by reference in their entirety.

Many variations of the present invention will suggest themselves to those skilled in the art in light of the above detailed description.

1. A method of transmitting information about a bleeding disorder to a healthcare provide for use with one or more patients having bleeding disorders, the method comprising the steps of:
providing the patient with a handheld device having a monitor with a touch screen and a processor;
displaying on the monitor a question indicative of whether the patient has taken a hemostatic medication prior to a bleeding episode;
receiving an answer from the patient as to whether a medication was administered before the bleeding episode began;
displaying on the monitor a question indicative of the time from the initial occurrence of the bleeding episode to the time of an infusion of an hemostasis product;
receiving an answer from the patient as to the time of the bleeding episode to the infusion;
displaying on the screen one or more pictures of the human body;
instructing the patient to indicate where bleeding is occurring by touching the picture in a location representative of the actual bleed;
receiving from the patient information as to the patients response to the infusion;
transmitting from the handhand held device to a centralized database at a location accessible to a healthcare provider information relating to location of the bleeding episode, time from onset of the bleeding episode to infusion, response to the infusion.

2. The method of claim 1 further comprising registering information about infusions of hemostasis agents from one of the patients having a bleeding disorder, wherein the information is entered via the handheld device and wherein the information entered comprises on or more of the following:
reasons for an infusion of a hemostasis product, number of infusions given in a predetermined time period, or number of bleeding episodes since last infusion of a hemostasis product.

3. The method of claim 1 where the patient is instructed to operate the device contemporaneously with a bleeding episode.

4. A system for collecting data relating to treating a patient having a bleeding disorder, the system comprising a handheld device having a touch screen display that displays one or more figures of the human body, an input mode for allowing a patient to enter location of a bleed by touching a corresponding part on the figure of the human body, the input mode allowing for entry of data relating to time from bleed to start of infusion of a self-administered hemostasis product and the input mode allowing for input of data relating to the success of the infusion in affecting the bleed, the system being configured to transmit data collected by the handheld device from the patient to a centralized processor, the centralized processor configured to compile data from multiple handheld devices.
